(19) United States
(12) Patent Application Publication
(10) Pub. No.: US 2004/0082886 A1
(43) Pub. Date: Apr. 29, 2004

(54) Therapeutic device for relieving pain and stress

(76) Inventor: Sandra Tee Timpson, Greenville, SC (US)

Correspondence Address: LITTMAN LAW OFFICES, LTD., P.O. BOX 15035 CRYSTAL CITY STATION, ARLINGTON, VA, 22215, US

(21) Appl. No.: 10/278,976

(22) Filed: Oct. 24, 2002

(51) Int. Cl. A61H 23/02

(52) U.S. Cl. 601/15; 601/46; 601/70

(57) ABSTRACT

A therapeutic device for relieving pain and stress in an extremity, i.e., a hand or a foot, includes a housing defining an enclosure having an opening to insert the extremity into the enclosure. The device also includes a heater and one or more vibrating squeezable member(s). The squeezable member recovers its shape when released. A hand or foot placed in the device rests on the squeezable member, and a gel pack rests against the back of the extremity transmitting heat from a heater to the extremity. A control unit can be operated to set or adjust the heater and vibratory member(s). The device can also be made portable by using batteries.

### BACKGROUND OF THE INVENTION

1. Field of the Invention

The present invention relates to a therapeutic device for relieving pain and stress in the extremities, i.e., the hands and feet. More particularly, the invention is a portable device providing heat and vibration therapy for a hand or foot, as well as for providing capability for relief of stress and tension using mechanotherapy in the form of a shape-retaining gripping object within the device.

2. Description of the Related Art

Mechanotherapeutic stress relief devices are relatively well known. These devices are typically referred to as “stress relievers” and are made in a wide variety of shapes and colors. They are typically made by molding a shape-retaining rubber shell and filling the molded shell with a putty-like composition. The rubber shell is shaped into such objects as the heads of caricatures, etc., and can be squeezed with the hand to relieve tension. These objects are often marketed as promotional items.

Other therapeutic devices are known for providing heat and vibration for the extremities to benefit sufferers of such joint and muscle diseases or conditions as arthritis, rheumatism, tendinitis, bursitis, carpal tunnel syndrome, etc.

However, none teach the combination of a mechanotherapeutic device with heat and vibration in the same device, particularly in a portable device.

U.S. Pat. No. 1,566,987, issued to Simmons on Dec. 22, 1925, describes a foot warmer using resistance heaters. U.S. Pat. No. 2,521,874, issued to Runstedler on Sep. 12, 1950, teaches a vibratory foot massage device. U.S. Pat. No. 3,055,357, issued to Redka on Sep. 25, 1962, discloses a foot bath in which the foot rests on a contoured surface.

U.S. Pat. No. 4,088,127, issued to Clayton et al. on May 9, 1978, shows a portable enclosed unit for massaging a hand, including a pliable fluid-filled bag. U.S. Pat. No. 4,513,736, issued to Thurber on Apr. 30, 1985, describes an enclosed cushioned foot or hand massager capable of both heating and vibrating. U.S. Pat. No. 4,979,502, issued to Hunt on Dec. 25, 1990, teaches a combined vibratory massage and heating device, e.g., a vest.

U.S. Pat. No. 5,369,807, issued to Cho et al. on Dec. 6, 1994, shows a circulating-fluid heating glove including a thermal gel pack. U.S. Pat. No. 5,605,533, issued to Badilla on Feb. 25, 1997, discloses a foot massage device using a plurality of balls on the bottom portion of the device which are connected to oscillating cranks that move in response to a motor and pulley system. U.S. Pat. No. 5,913,838, issued to Reilly on Jun. 22, 1999, teaches a battery-operated vibratory shoe insert. U.S. Pat. No. 6,165,208, issued to Reyes et al. on Dec. 26, 2000, describes a sweatband including a battery-operated resistance heater.

Deformable putties are known in the art, such as the “bouncing” putty described in U.S. Pat. No. 2,541,851, issued Feb. 13, 1951 (putty obtained by treating dimethyl silicones with a boron compound and heat or a catalyst) and mentioned further in an Inventor of the Week note (undated) on MIT's Internet site at http://web.mit.edu...-H/sillyputty.html.

Although various devices are taught that use therapeutic techniques such as heat and vibration, none teach a portable unit having the combination of heat, vibration and mechanotherapeutic massage as taught by the present invention.

None of the above inventions and patents, taken either singly or in combination, is seen to describe the instant invention as claimed. Thus a therapeutic device for relieving pain and stress solving the aforementioned problems is desired.

### SUMMARY OF THE INVENTION

The therapeutic device for relieving pain and stress of the present invention is a portable unit in which heat, vibration and mechanical (grip) massage are integrally provided in the same unit. The device has a housing which includes an upper compartment and a lower compartment, or base. The base houses a power supply unit, which may be an A.C. supply or batteries, and a vibratory mechanism. The upper compartment houses at least one resilient, compressible element connected to the vibratory mechanism by a support member, a gel pack disposed above the compressible element, and a heating element thermally connected to the gel pack so that a body member, e.g., a hand or foot, inserted into the upper compartment is heated while receiving a soothing massage through the vibrating, resilient, compressible element.

The device may be configured with a single compressible element with the upper compartment, being configured for receiving a hand to provide pain and stress relief for the hand and fingers, or with multiple compressible elements, being configured to provide pain and stress relief to a foot.

Accordingly, it is a principal object of the invention to provide a device for providing therapy in the form of heat, vibration and grip.

It is a further object of the invention to provide the above therapeutic device in a portable unit.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is a perspective view of a therapeutic device for relieving stress and pain in the hand according to the present invention.

FIG. 2 is a vertical, longitudinal, section view of the device of FIG. 1.

FIG. 3 is a perspective view of a therapeutic device for relieving stress and pain in the foot according to the present invention.

FIG. 4 is a vertical, longitudinal, section view of the device of FIG. 3.

Similar reference characters denote corresponding features consistently throughout the attached drawings.

### DETAILED DESCRIPTION OF THE PREFERRED EMBODIMENTS

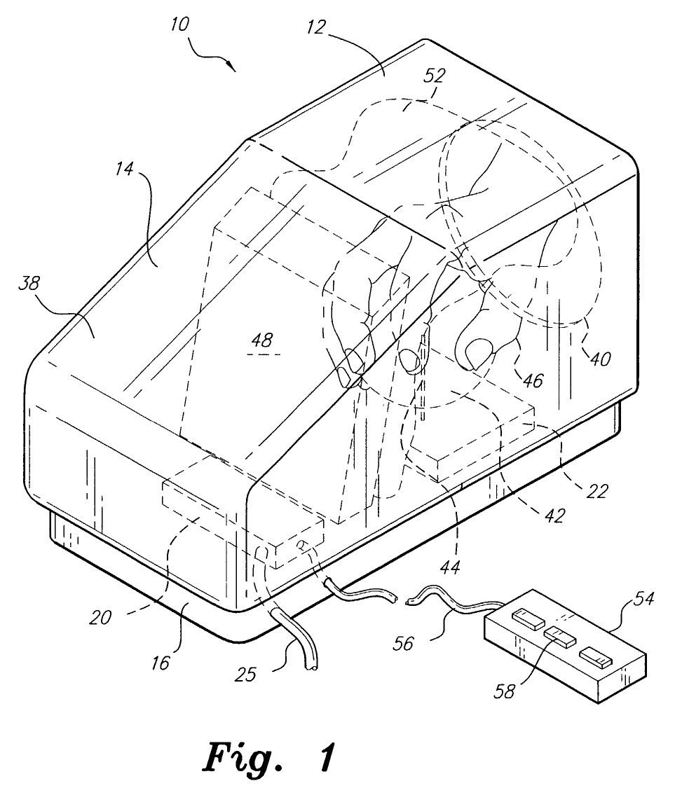

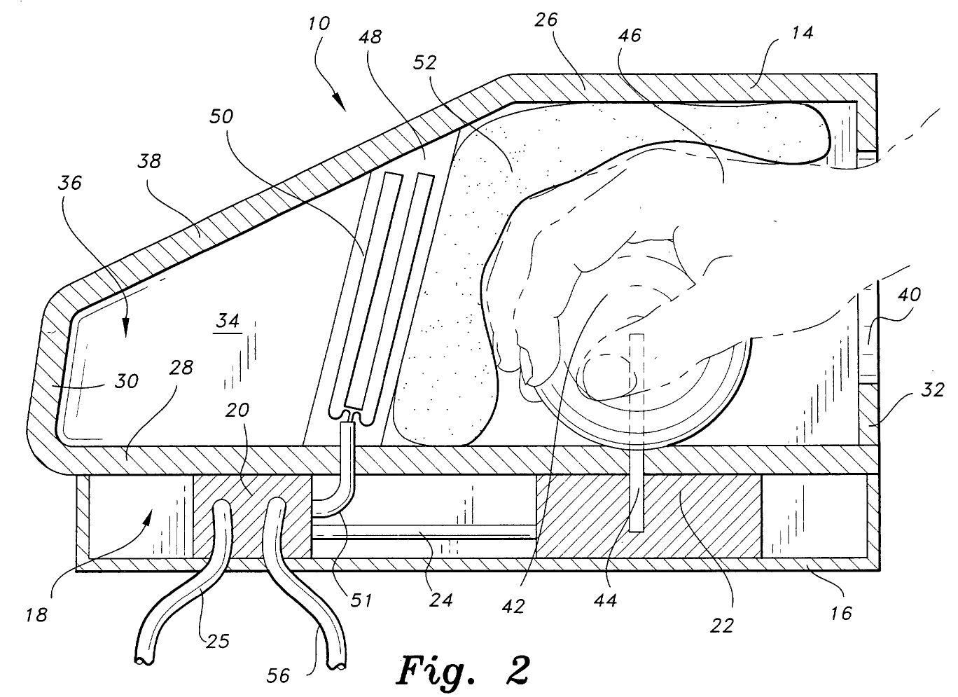

The present invention is directed to a therapeutic device for relieving stress and pain in an extremity, namely a hand or a foot. FIGS. 1 and 2 show an embodiment of the device, designated generally as 10 in the drawings, which is configured for providing pain and stress relief to the hand and fingers of the user.

The device 10 has a housing 12 which includes an upper housing enclosure 14 and a lower base unit 16 which are attached to each other by appropriate fasteners (not shown). The base unit 16 has a generally flat, rectangular box shape which defines a lower compartment 18. A power supply unit 20 and a vibratory mechanism 22, both shown diagrammatically in the drawings, are disposed in the base unit 16, the vibratory mechanism 22 being connected to the power supply unit 20 by appropriate wiring 24. The power supply unit 20 may comprise a dry cell battery supply (alkaline batteries, rechargeable nickel-cadmium (NiCad) batteries, rechargeable nickel metal hydride (NiMH) batteries, etc.), or the power supply unit may comprise an A.C. power supply unit adapted for connection to a wall outlet through cord 25, depending upon the power requirements of the particular devices used to provide the vibratory mechanism 22 and heating element (discussed below). Both battery and A.C. power supply units are conventional and well known in the art, so that the structure of the power supply unit 20 will not be further described.

The vibratory mechanism 22 may comprise a piezoelectric transducer, an electromagnet or solenoid configured with a vibrating armature, a motor having a cam attached to its shaft in which a lobe of the cam intermittently causes a spring-biased element to vibrate, or by any other device known in the art for producing vibratory movement.

Upper housing enclosure 14 is shown in FIGS. 1 and 2 as a substantially rectangular, box shaped enclosure having a top wall 26, a bottom wall 28, a front wall 30, a rear wall 32, and two elongated, opposing side walls 34. The upper housing enclosure 14 defines an upper compartment 36. The height of the front wall 30 may be lower than the height of the rear wall 32 and the top wall 26 may have a canted or sloped portion 38 which reduces the volume of the upper compartment 36. The bottom wall 28 of the upper housing enclosure 14 may defined a partition wall separating the upper compartment 36 from the lower compartment 18. The rear wall 32 has an opening 40 defined therein having a diameter large enough for a user of the therapeutic device 10 to insert his hand into the upper compartment 36. It will be understood, however, that the particular shape of the upper housing enclosure 14, including the canted portion 38 of the top wall 26, is not an essential feature of the therapeutic device 10, and any shape of housing capable of enclosing the elements described below and providing an enclosed structure for administering the pain and stress relief therapy to the hand is consistent with the present invention.

Disposed within the upper compartment is a resilient, compressible element 42 which is attached to the vibratory mechanism 22 by a support member, e.g., a pin 44, which translates vibratory movement from the vibratory mechanism 22 to the compressible member 42. Compressible member 42 is shown in the shape of a sphere or ball; however, the compressible member 42 may have any other shape which provides support for the hand and has a surface area large enough to receive the palmar surface of the hands and fingers. The compressible member 42 should have sufficient flexibility so that the compressible member 42 is deformable by the application of flexion of the hand 46 and fingers, and so that the vibratory motion induced by the vibratory mechanism 22 is translated by the support member 44 to the medium of the compressible member 42 to massage the hand and fingers, but is sufficiently resilient to return to its original shape upon removal of the compressive force or vibratory motion. The compressible member 42 may be made, e.g., from a deformable medium, such as an elastomeric, silicone-based, putty-like material (such as Silly Putty®), a vinyl elastomer, or a silicon-based gel, which is encased in a flexible, resilient shell made from, e.g., silicone rubber. Alternatively, the compressible member may be made from foam rubber, or may be made entirely from silicone rubber.

Also disposed in the upper compartment 36 is a heater block 48 having resistive heater elements 50, or other heating means, contained therein electrically connected to the power supply unit 20 by appropriate wiring 51,. The upper compartment 36 also contains one or more gel packs 52 which are attached to the top wall 26 and/or the heater block 48, so that heat generated by the heater block 48 is transported to the gel pack 52, preferably by conduction. The gel pack 52 may be suspended from the top wall 26 by a resilient foam cushion (not shown) so that when the user inserts his or her hand 46 into the upper compartment, the gel pack 52 is resiliently urged into contact with the dorsal surface of the hand 46, or the gel pack 52 may be adhesively attached directly to the top wall 26. The media in the gel pack 52 evenly distributes heat generated by the heater block 48 and provides a cushioned interface for applying heat to the hand 46 for the relief of pain and stress. Gel packs 52 for retaining and distributing heat are well known. An exemplary gel pack suitable for use in the present invention is the NEXCARE line of reusable hot/cold packs for the relief of pain made by 3M (Minnesota Mining and Manufacturing Company) of St. Paul, Minn.

The therapeutic device 10 may include a control unit 54 either built in to the housing 12, or as an external unit connected to the power supply unit 20 and to the vibratory mechanism 22 and/or the heater block 48 by appropriate wiring 56. The control unit 54 includes suitable electrical switches 58 for controlling the amount of vibratory movement produced by the vibratory mechanism 22, and for controlling the amount of heat produced by the heater block 48, including turning the vibratory mechanism and/or heater block 48 on and off.

In use, the user inserts his or her hand 46 through the opening 40 in the rear wall 32 and places the palm of the hand and fingers on the compressible element 42 and grips the element 42 for comfort. Control unit 54 may be used to apply vibration produced by vibratory mechanism 22 to the compressible member 42 to massage the hand 46. Gel pack 52 closely approximates the dorsal aspect of the hand. Control unit 54 may be used to apply heat produced by heater block 48 to the gel pack 52 and thence to the hand 46 to that the hand 46 may be both heated and massaged while squeezing compressible element 42 for the relief of stress and pain in the hand 46.

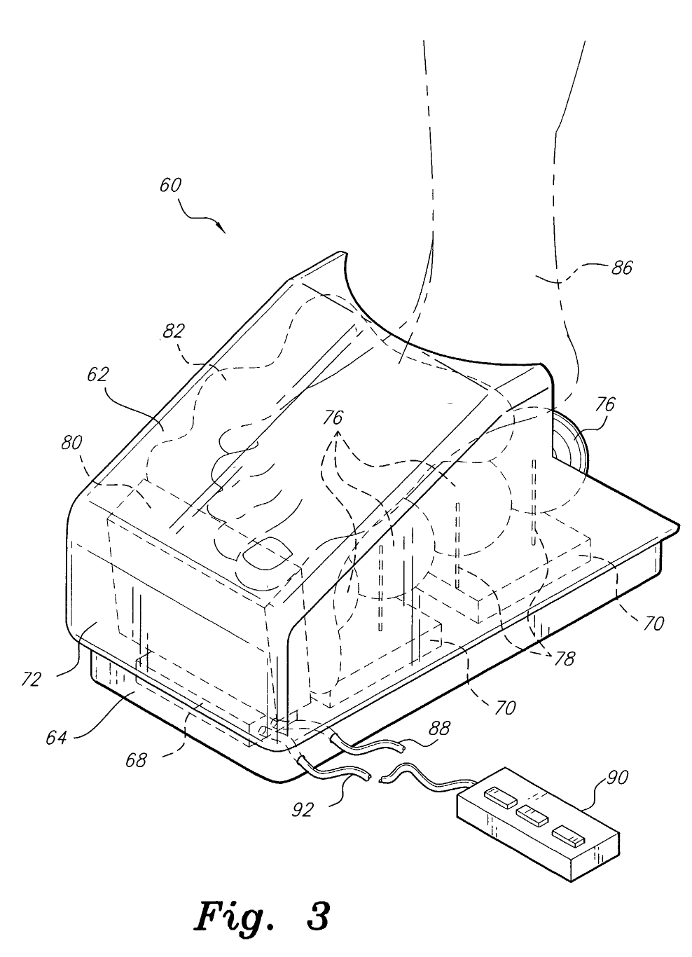

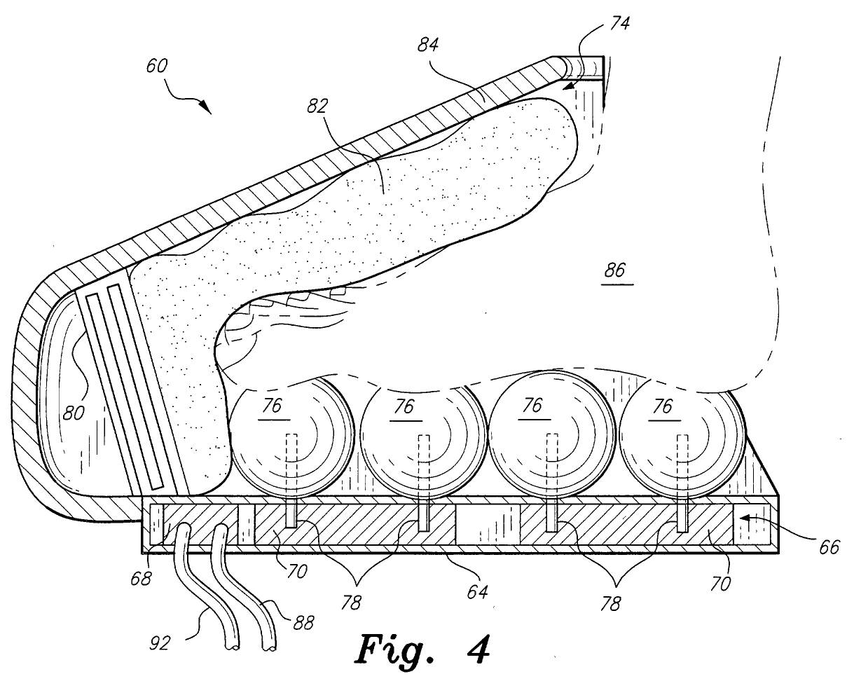

FIGS. 3 and 4 show a second embodiment of the therapeutic device, designated generally as 60 in the drawings, which is adapted for relieving stress and pain in the foot. The device 60 is similar to the therapeutic device 10 for the hand, and includes a housing 62 having a base unit 64 defining a lower compartment 66 housing a power supply unit 68 and one or more vibratory mechanism(s) 70. Upper housing enclosure 72 is attached to the base unit 64 and defines an upper compartment 74 which houses one or more compressible elements 76 connected to vibratory mechanism(s) 70 by support member(s) (pins) 78, a heater block 80, and a gel pack 82 attached to the top wall 84 of upper housing enclosure 72. Power supply unit 68, vibratory mechanism(s) 70, compressible element(s) 76, heater block 80, and gel pack 82 are identical in construction to power supply unit 20, vibratory mechanism 22, compressible member 42, heater block 48, and gel pack 52, respectively, and will not be described further. The therapeutic device 60 for the foot differs from the therapeutic device 10 for the hand primarily because upper compartment 74 is dimensioned and configured for receiving the user's foot 86, so that upper housing enclosure 72 may lack a rear wall in order to provide an opening large enough to receive the foot 86, and because the device 60 may include a plurality of compressible elements 76 aligned longitudinally for application to the sole of the foot 86, and may have a plurality of vibratory mechanisms 70 for imparting vibratory motion to compressible elements 76. As with the therapeutic device 10 for the hand, therapeutic device 60 the power supply unit 68 may be battery powered, or may be connected to an A.C. outlet by cord 88, and control unit 90, attached to the device 60 by wiring 92, may be used to adjust the degree of vibration and the amount of heat supplied in the same manner as control unit 54.

In use, the user inserts his or her foot 86 through the opening defined in the rear of the housing 62 and into the upper compartment 74, resting the plantar surface of the foot 86 on the plurality of compressible elements 76. The dorsal surface of the foot 86 is in contact with gel pack 82. The user may activate and adjust vibration of the compressible elements 76 through control unit 90, which is electrically connected to the vibratory mechanisms 70, in order to massage the sole of the foot 86, and may also activate and adjust heater block 80 through the control unit 90 to apply heat to the dorsal surface of the foot 86 as desired.

The therapeutic devices 10 and 60 are portable, and may therefore be used in any setting for the relief of stress and pain. The device may be used by the casual user for the relief of stress from such leisure activities as driving, or for sports injuries, as well as for the relief of stress and pain after work activities, by typists, data entry personnel, manicurists, etc., and may also be used by medical professionals for physical therapy and the like.

It is to be understood that the present invention is not limited to the embodiments described above, but encompasses any and all embodiments within the scope of the following claims.

We claim:

1. A therapeutic device for relieving stress and pain, comprising:
a housing defining an enclosure dimensioned and configured for receiving an extremity of a human body, the housing having an opening defined therein adapted for insertion of the extremity through the opening and into the enclosure;
at least one resilient, compressible member disposed within said housing, the at least one compressible member being adapted for supporting the extremity;
a vibratory mechanism connected to said compressible member for imparting vibratory movement to said compressible member; and
heating means disposed within said housing for applying heat to the extremity;
whereby the extremity is massaged and heated while applying pressure to the compressible member for relief of stress and pain.

2. The therapeutic device of claim 1, wherein said housing comprises a base unit and an upper housing enclosure mounted above said base unit, wherein said vibratory mechanism is disposed within said base unit and wherein said at least one compressible member and said heating means are disposed within said upper housing enclosure.

3. The therapeutic device of claim 1, further comprising a support element, said compressible member being mounted on said support element, said support element being connected to said vibratory mechanism for translating vibratory movement produced by said vibratory mechanism to said compressible member.

4. The therapeutic device according to claim 1, wherein said compressible member comprises a flexible resilient shell and a deformable material disposed within said shell, the deformable material being selected from the group consisting of an elastomeric, silicone-based, putty-like material, a vinyl elastomer, or a silicon-based gel.

5. The therapeutic device according to claim 1, wherein said compressible member is made from foam rubber.

6. The therapeutic device according to claim 1, wherein said compressible member is made from silicone rubber.

7. The therapeutic device according to claim 1, wherein said compressible member is; spherically shaped.

8. The therapeutic device according to claim 1, wherein said heating means comprises a heater block having resistive heating elements disposed therein.

9. The therapeutic device according to claim 8, wherein said heating means further comprises a gel pack attached to said housing and disposed above said compressible element, wherein heat generated by said heater block is transported to said gel pack by thermal conduction so that the gel pack evenly distributes heat to the extremity.

10. The therapeutic device according to claim 1, wherein said at least one compressible member consists of a single spherically shaped compressible member dimensioned and configured for supporting a human hand.

11. The therapeutic device according to claim 1, wherein said at least one compressible member comprises a plurality of spherically shaped compressible members aligned longitudinally and dimensioned and configured for supporting a human foot.

12. The therapeutic device according to claim 1, further comprising a power supply unit disposed within said housing.

13. The therapeutic device according to claim 12, wherein said power supply unit comprises at least one battery.

14. The therapeutic device according to claim 12, wherein said power supply unit comprises an A.C. power supply having a power cord adapted for connection to an A.C. power source.

15. The therapeutic device according to claim 1, further comprising a control unit having at least one switch connected to said vibratory mechanism for controlling vibratory movement produced by said vibratory mechanism, including switching power to said vibratory mechanism on and off.

16. The therapeutic device according to claim 1, further comprising a control unit having at least one switch connected to said heating means for controlling heat produced by said heating means, including switching power to said heating means on and off.

17. A therapeutic device for relieving stress and pain, comprising:
a housing defining an enclosure having an upper compartment and a lower compartment, the upper compartment being dimensioned and configured for receiving an extremity of a human body, the upper compartment having an opening defined therein adapted for insertion of the extremity through the opening and into the upper compartment;
at least one resilient, compressible member disposed within the upper compartment of said housing, the at least one compressible member being adapted for supporting the extremity;
a vibratory mechanism disposed in the lower compartment and connected to said compressible member for imparting vibratory movement to said compressible member;
a heater block and a gel pack disposed in contact with said heater block, the heater block and the gel pack being disposed in the upper compartment with the gel pack above said compressible element for applying heat to the extremity;
a power supply unit disposed in the lower compartment, said vibratory mechanism and the heater block being electrically connected to said power supply unit; and
a control unit having at least one switch connected between said power supply unit and said vibratory mechanism, and having at least one switch connected between said power supply unit and said heater block for controlling vibratory movement produced by said vibratory mechanism and heat produced by said heater block, respectively;
whereby the extremity is massaged and heated while applying pressure to the compressible member for relief of stress and pain.

18. The therapeutic device according to claim 17, wherein said at least one compressible member comprises:
a shell made from a flexible, resilient material; and
a deformable medium encased in said shell.

19. The therapeutic device according to claim 18, wherein said shell is made from silicone.

20. The therapeutic device according to claim 18, wherein said deformable medium comprises an elastomeric, silicone-based, putty-like material.
